(19) United States
(12) Patent Application Publication
(10) Pub. No.: US 2025/0317533 A1
(43) Pub. Date: Oct. 9, 2025

(54) INTELLIGENT CATEGORIZATION AND ORGANIZATION OF A VIRTUAL MEETING RESOURCE BASED ON A MEETING DISCUSSION

(71) Applicant: Google LLC, Mountain View, CA (US)

(72) Inventors: Ethan Samuel Shernan, Snoqualmie, WA (US); Yan Liu, Sammamish, WA (US); Jan Arvid Kristoffer Callas, Sammamish, WA (US); Dmitry Denisovich Levin, Sammamish, WA (US); Kevin Jonathan Jeyakumar, West Palm Beach, FL (US)

(21) Appl. No.: 19/172,418

(22) Filed: Apr. 7, 2025

Related U.S. Application Data
(60) Provisional application No. 63/631,324, filed on Apr. 8, 2024.

(51) Int. Cl. H04N 7/15; G06F 9/451

(52) U.S. Cl. CPC H04N 7/155; G06F 9/451

(57) ABSTRACT

Aspects of the disclosure are directed to intelligent categorization and organization of a virtual meeting resource based on a meeting discussion. A transcript for at least a portion of a virtual meeting is obtained. A set of discussion topics of a discussion of the virtual meeting is determined based on the obtained transcript. A set of topic summaries each summarizing a respective topic of the set of topics that is discussed at various points in time during the virtual meeting is obtained based on the obtained transcript and the set of topics. An overview of the virtual meeting is generated. The overview includes the set of topic summaries in association with respective topics discussed at various points of time during the virtual meeting.

### CLAIM OF PRIORITY

The present application claims the benefit under 35 U.S.C. §119(e) of U.S. Provisional Patent Application No. 63/631,324 filed Apr. 8, 2024, which is incorporated by reference herein.

### TECHNICAL FIELD

Aspects and implementations of the present disclosure relate to intelligent categorization and organization of a virtual meeting resource based on a meeting discussion.

### BACKGROUND

A platform can enable users to connect with other users through a video-based or audio-based virtual meeting (e.g., a conference call). The platform can provide tools that allow multiple client devices to connect over a network and share each other's audio data (e.g., a voice of a user recorded via a microphone of a client device) and/or video data (e.g., a video captured by a camera of a client device, etc.) for efficient communication.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes obtaining a transcript for at least a portion of a virtual meeting. The method further includes determining a set of discussion topics of a discussion of the virtual meeting based on the obtained transcript. The method further includes obtaining, based on the obtained transcript and the set of topics, a set of topic summaries each summarizing a respective topic of the set of topics that is discussed at various points in time during the virtual meeting. The method further includes generating an overview of the virtual meeting. The overview includes the set of topic summaries in association with respective topics discussed at various points of time during the virtual meeting.

In some implementations, determining the set of discussion topics of the discussion includes providing the transcript as input to a first artificial intelligence (AI) model that is trained to predict one or more discussion topics of a discussion based on given transcript data. The method further includes obtaining one or more outputs of the first AI model.

In some implementations, obtaining the set of topic summaries includes providing the transcript as input to a second AI model that is trained to generate a summary of a discussion of a virtual meeting based on given transcript data. The method further includes obtaining one or more outputs of the second AI model.

In some implementations, the transcript is a live transcript obtained while the virtual meeting is being conducted. The live transcript includes current content discussed by a set of participants of the virtual meeting.

In some implementations, the method further includes updating a user interface (UI) of the virtual meeting to include the generated overview for presentation to the set of participants during the virtual meeting.

In some implementations, the method further includes obtaining, during a subsequent time period of the virtual meeting, the live transcript for at least another portion of the virtual meeting. The method further includes obtaining an updated topic summary that summarizes the respective topic discussed at the subsequent time period. The method further includes updating the overview of the virtual meeting to include the updated topic summary in association with the respective topic.

In some implementations, the transcript is a post-meeting transcript generated based on a complete discussion of participants during the virtual meeting.

In some implementations, a respective topic summary that summarizes the respective topic of the discussion includes one or more of an indication of an evolution of a status of the respective topic between an initial time period of the discussion and a subsequent time period of the discussion, or an indication of a final status pertaining to the respective topic at a final time period of the discussion.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example meeting resource engine, in accordance with implementations of the present disclosure.

FIG. 3 depicts a flow diagram of an example method for generating a meeting overview of a virtual meeting, in accordance with implementations of the present disclosure.

FIG. 4 depicts a flow diagram of an example method for customizing an organization or categorization of a meeting resource based on a meeting discussion, in accordance with implementations of the present disclosure.

FIG. 5 depicts a flow diagram of an example method for identifying relevant discussion points of a virtual meeting, in accordance with implementations of the present disclosure.

FIGS. 6A-6B illustrate example user interfaces (UIs), in accordance with implementations of the present disclosure.

FIGS. 7A-7B illustrate example meeting resources generated for a virtual meeting, in accordance with implementations of the present disclosure.

FIG. 8 depicts a flow diagram of another example method for customizing an organization or categorization of a meeting resource based on a meeting discussion, in accordance with implementations of the present disclosure.

FIG. 9 illustrates an example predictive system, in accordance with implementations of the present disclosure.

FIG. 10 is a block diagram illustrating an exemplary computer system, in accordance with implementations of the present disclosure.

### DETAILED DESCRIPTION

Aspects of the present disclosure relate to intelligent categorization and organization of a virtual meeting resource based on a meeting discussion. A platform can enable users to connect with other users through a video or audio-based virtual meeting (e.g., a conference call, etc.). During or after a virtual meeting, participants may want to review key information associated with the virtual meeting discussion, clarify action items discussed during the meeting, and/or ensure alignment on decisions made by the participants during the meeting. While using conventional virtual meeting platforms to conduct virtual meetings, such participants may manually take notes on the discussion topics in order to capture the above information. However, manually taking notes can be burdensome, as it can cause a participant to divide their attention between actively participating in the meeting and memorializing points of interest. It can take a significant amount of time for a user to update manually created meeting notes and, in some instances, other participants of the virtual meeting may pause the discussion until the participant has completed updating the meeting notes and has rejoined the discussion. During such time when the discussion is paused, computing resources (e.g., processing cycles, network resources, memory resources, etc.) can be consumed (e.g., by the platform, by client devices of the participants, etc.) to maintain the virtual meeting environment. Such resources are unavailable for other processes, which can increase an overall latency and decrease an overall efficiency of the system.

Additionally, a participant who joins a virtual meeting after the meeting has started can experience confusion related to meeting discussions (e.g., a current meeting topic, material presented during the meeting, whether such participant's input was requested prior to the user joining the meeting, etc.) and may not be able to provide input on the points being discussed. Such participant may interrupt the current discussion to ask the other participants questions about what was previously discussed, which can interrupt the flow of the discussion and therefore cause the virtual meeting to take a longer period of time (e.g., in order to ensure that all points intended for discussion during the virtual meeting are addressed). By extending the duration of the virtual meeting, additional computing resources are consumed (e.g., by the platform, by the client devices, etc.), which can further increase the overall latency and decrease the overall efficiency of the system.

A topic of a virtual meeting can be revisited multiple times throughout the meeting discussion and, in some instances, decisions regarding the topic may evolve based on the perspectives and points raised by participants. A system or platform can provide users, whether they participated in the virtual meeting or not, with a meeting transcript during or after the meeting. While a meeting transcript can document the discussion points and identify which participants contributed, it can be challenging for users to pinpoint the final decision or outcome relating to a specific topic. Additionally, following the thread of the discussion for that topic can be difficult. This can lead to confusion and potential misinterpretation of the meeting discussion, causing users to spend additional time accessing and analyzing the meeting transcript. Furthermore, participants may have different priorities or goals based on their roles, making some discussion points more relevant to certain participants than others. It can be difficult for a participant to easily identify discussion points that are relevant to them, further increasing the time spent accessing the transcript. This additional time can lead to increased consumption of computing resources, which can further increase the overall latency and decrease the overall efficiency of the system.

Implementations of the present disclosure address the above and other deficiencies by providing methods and systems for intelligent categorization and organization of a virtual meeting resource based on a meeting discussion. In some embodiments, a platform (e.g., a virtual meeting platform) can provide users with access to tools or functionalities associated with the automatic generation of meeting resources pertaining to a virtual meeting. A meeting resource can include meeting minutes, a meeting summary, an action item (e.g., or list or action items) corresponding to a context or a sentiment of a virtual meeting discussion. Such tools or functionalities are described herein as an “automated meeting resource” feature. In some embodiments, before or during a virtual meeting, a participant of the virtual meeting can initiate the automated meeting resource feature. (e.g., by engaging with one or more user interface (UI) elements of a UI associated with the virtual meeting, by providing a verbal or textual command associated with initiating the automated meeting resource feature, etc. Upon initiation of the automated resource feature, the platform can obtain a live transcript (e.g., a transcript reflecting verbal and/or textual statements of the participants that is generated in real-time or approximately real-time) of a discussion of the virtual meeting and, as will be seen below, can perform one or more operations associated with the context and/or the sentiment of the meeting discussion, in some embodiments. Upon completion of the virtual meeting, the platform can obtain a post-meeting transcript (e.g., based on the live transcript), which reflects the entire conversation or discussion of the virtual meeting.

In some embodiments, the platform can determine two or more discussion topics of a discussion of the virtual meeting based on the live transcript (e.g., during the virtual meeting) and/or based on the post-meeting transcript (e.g., after completion of the virtual meeting). A discussion topic refers to a subject or area of focus that is discussed by two or more participants of the virtual meeting. A discussion topic may be identified prior to the virtual meeting (e.g., as included in an agenda for the meeting) or may be brought up organically based on the discussion between participants in the virtual meeting. In some embodiments, the platform can determine the discussion topic(s) of the virtual meeting discussion based on one or more outputs of one or more AI models trained to predict a topic of a discussion based on given input data.

In some embodiments, the platform can additionally or alternatively obtain topic summaries each summarizing a respective topic discussed throughout the virtual meeting. In some embodiments, the platform can obtain a topic summary summarizing a respective topic of discussion as an input to the one or more AI models trained to generate or otherwise obtain a summarization of discussion points associated with an identified topic of the virtual meeting discussion. In some embodiments, the platform can provide the live transcript generated during the virtual meeting as an input to the AI model, which can generate a current summarization of a respective topic as previously or currently discussed during the virtual meeting. As the virtual meeting continues, the platform can provide the updated live transcript (e.g., reflecting later points of the discussion) as an input to the AI model, which can generate an updated summarization of the respective topic based on the current discussion points of the virtual meeting and/or the prior current summarization (e.g., now a prior summarization) for the discussion topic. As the platform obtains an updated summarization of a respective topic of discussion during the meeting, the platform can continuously update a UI of the virtual meeting to present the updated summarization of the discussion topic to participants of the conference call discussion. In other or similar embodiments, can provide a post-meeting transcript (e.g., reflecting the entire conversation or discussion of the virtual meeting) as an input to the AI model, which can generate a summarization of each identified topic discussed during the virtual meeting.

In some embodiments, the platform can generate or otherwise update an electronic document to include an overview of the virtual meeting, which includes the topic summaries generated for each identified topic of the meeting discussion. In accordance with embodiments described herein, the overview can include summaries of each respective discussion topic in view of the evolution of the discussion throughout various points of time during the virtual meeting. In an illustrative example, participants of a virtual meeting may discuss a topic during an initial time period and arrive at a first conclusion with respect to the topic, and later may discuss the topic during a subsequent time period (e.g., after discussing other topics) and, at the subsequent time period, may arrive at a second conclusion with respect to the topic. The overview of the virtual meeting may include a summarization associated with the discussion topic that reflects the second conclusion with respect to the topic and/or the evolution of the thread of the discussion between the initial time period and the subsequent time period.

In additional or alternative embodiments, the platform can identify characteristics associated with respective participants of the virtual meeting and may generate multiple summarizations of the discussion points during the virtual meeting in view of such identified characteristics. Example characteristics can include, but are not limited to, a role of a respective participant (e.g., in the meeting, in an organization, etc.), a position or title of the participant, an area of expertise of the participant (e.g., a technical expert, a business analyst, a financial representative, etc.), a relationship of the participant to the project or the topic, and so forth. Each generated summarization may be unique in view of the characteristics associated with each respective participant, in some embodiments. In an illustrative example, participant(s) of a virtual meeting can include a technical expert participant and a business analyst participant. The platform can identify a role or area of expertise of such participants (e.g., based on information included in an account associated with such participants, based on a context or sentiment of the virtual meeting discussion, etc.) and can provide an indication of such role or area of expertise as an input to an AI model that is trained to generate an overview of summarized discussion points during the virtual meeting. In some embodiments, the platform can obtain multiple generated overviews from the AI model, including a first overview generated based on the role or area of expertise of the technical expertise and a second overview generated based on the role or area of expertise of the business analyst. The first overview may include or otherwise highlight different points of the virtual meeting discussion (e.g., which are relevant to the technical expert) than points included or highlighted by the second overview (e.g., which are relevant to the business analyst).

Aspects of the present disclosure provide techniques for intelligent categorization and organization of a virtual meeting resource based on a meeting discussion and/or characteristics of participants of the meeting discussion. These techniques enable the use of AI models to generate or obtain meeting resources that are accessible to participants during or after a virtual meeting. In accordance with embodiments of the present disclosure, a platform can provide participants with access to automatically generated/updated meeting resources, preventing the participants from manually creating and updating such resources. Accordingly, participants of a virtual meeting can be engaged with the virtual meeting discussion, maintaining the flow of the conversation and, in some instances, reducing the overall time for the virtual meeting, which can decrease the overall amount of computing resources (e.g., processing cycles, memory space, network bandwidth, etc.) consumed during the virtual meeting. Further, the platform can provide late-joining participants access to the meeting resources obtained in accordance with embodiments described herein, allowing such participants to be caught up on what was previously covered during the meeting, further minimizing the number of distractions or disruptions during the virtual meeting.

Further, embodiments of the present disclosure enable the generation of meeting resources, such as meeting minutes, summaries, and overviews, that are organized or customized based on the topics discussed and/or the characteristics of the participants. For instance, embodiments of the present disclosure allow for the creation of a meeting overview that includes a summary of a topic, reflecting the final outcome of the discussion and the evolution or thread of the discussion throughout the meeting. This enables users, whether participants or non-participants, to ascertain the final decision or outcome related to a specific topic, thereby avoiding confusion and potential misinterpretation of the meeting discussion. It also reduces the time users spend accessing the meeting resource to obtain relevant information. Additionally, embodiments of the present disclosure support the generation of multiple overviews that summarize topics relevant to specific participants based on their characteristics. This allows users to quickly identify discussion points pertinent to them, further reducing the time spent accessing the meeting resource. By minimizing the time users spend on meeting resources, the system consumes fewer computing resources, which decreases overall latency and increases system efficiency.

Implementations described herein may involve the collection of data describing a user and/or activities of a user. To address the privacy of users, various techniques may be implemented. In one implementation, the collection of such data occurs only after the user provides consent. In some implementations, a user may be presented with a prompt to explicitly allow the collection of this data. In the instance where the user consents to the use of such data, the data may be used for the described functionalities._{[LG1]}

Prior to the system enabling collection of user information (e.g., facial features), a user may be provided with controls allowing the user to make an election as to both if and when the system may enable such collection. For in-room participants, clear and conspicuous information regarding the data collection may be provided before their participation. This information may include the fact that the system processes video to create facial embeddings for identification, and that full photographic images may not be stored. The purpose of this processing may be to provide individual recognition of in-room participants to enhance the virtual meeting experience. Details regarding how facial embeddings and associated identifiers may be used within the meeting context may also be provided.

In some implementations, users may be informed of the security measures in place to protect facial embeddings, such as encryption prior to being stored. Information regarding how long facial embeddings may be retained and the procedures for their removal may also be provided. Users may be informed of their options regarding their biometric data. Contact information for privacy-related questions may be made available. Methods of providing such information may include in-room displays or a companion application for in-room participants, and the platform user interface for remote participants.

In some implementations, the system may obtain an affirmative indication from in-room participants prior to facial identification. For instance, in the instance where a user consents to the association of a detected facial region with their identifier, the system may record this association. For automatic identification based on facial features, prior affirmative indication may be obtained for the enrollment and storage of these features. Alternative methods for in-room participants to indicate their presence without using facial recognition may be available. Participants may be informed of their ability to withdraw their consent and may be provided with mechanisms to do so, such as leaving camera view or using a user interface control. The consequences of withdrawing consent may be clearly communicated.

Users may have the ability to review and potentially modify their stored facial feature data. Users may also have the ability to remove their stored facial feature data. The ability to disable automatic identification within meeting or profile settings may be provided to users. If a misidentification occurs, mechanisms for a user to correct this may be available.

In some implementations, the system may store only facial embeddings derived from photos and may not retain the full photographic images. Client devices may, in some implementations, derive facial embeddings locally before sending them to a server. Biometric data processed for identification and association during a meeting may be temporary. Data describing facial features may be retained only for the minimum duration required for meeting functionality and may be removed shortly after the meeting concludes unless an affirmative indication is provided for longer retention to potentially improve future accuracy. The use of facial feature data may be limited to the purpose of identifying in-room participants within virtual meetings.

Data describing facial features may be treated in one or more ways before it is stored or used, so that personally identifiable information is removed. For example, a user's identity may be treated so that no personally identifiable information can be determined for the user. Access to stored facial feature data may be controlled to limit which components and personnel can access it.

The system may be designed to align with privacy considerations. Where technically viable, processing of facial features for matching may occur locally on the client device against a downloaded set of meeting participant features to reduce server-side processing. Measures to reduce the risk of unintentionally capturing and processing biometric data of individuals not participating in the meeting may be implemented. Privacy considerations may be addressed in the design of application programming interfaces (APIs), such as not retaining detailed data in logs and enforcing strong security for data retrieval. A description of the retention periods and data removal procedures for all collected and processed data related to this system may be documented.

Workspace administrators may be provided with controls to manage implementations within their domain, including the ability to enable or disable it for specific units or users and potentially remove enrollment data. Features for reviewing the usage of automatic identification may be implemented to support accountability.

It should be noted that although aspects of the present disclosure are described with reference to a conference room, they should not be so limited, and can be used in any other space or location allowing a group setting for participating users.

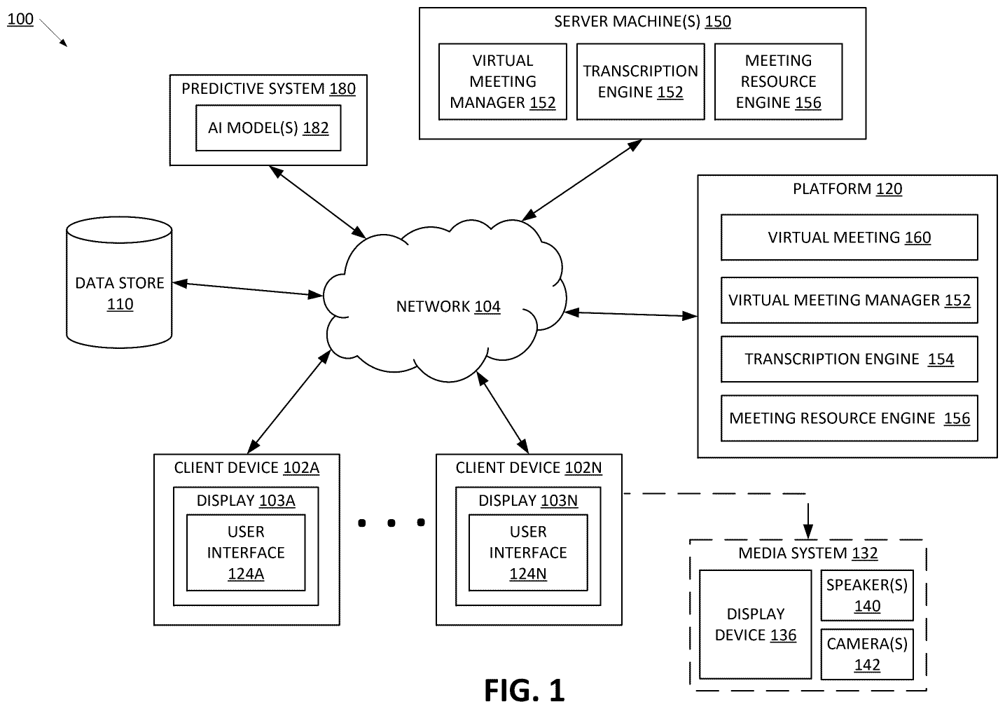

FIG. 1 illustrates an example system architecture 100, in accordance with implementations of the present disclosure. The system architecture 100 (also referred to as “system” herein) includes client devices 102A-N (collectively and individually referred to as client device 102 herein), a data store 110, a platform 120, and/or one or more server machines 150, each connected to a network 104. In implementations, network 104 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more video streams, audio streams, and/or meeting transcripts that can be used to generate meeting resources (e.g., at predetermined time intervals) and/or to generate the electronic documents (e.g., at a time after the end of the virtual meeting). Data store 110 can be hosted by one or more storage devices, such as main memory, magnetic or optical storage-based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 104.

Platform 120 can enable users of client devices 102A-N to connect with each other via a virtual meeting (e.g., virtual meeting 160). The virtual meeting 160 can be a video-based virtual meeting, which includes a meeting during which a client device 102 connected to platform 120 captures and transmits video streams (e.g., collected by a camera of a client device 102) and/or audio streams (e.g., collected by a microphone of the client device 102) to other client devices 102 connected to platform 120. The video streams can, in some embodiments, depict a user or group of users that are participating in the virtual meeting 160 (also referred to as participants). The audio streams can include, in some embodiments, an audio recording of audio provided by the user or group of users during the virtual meeting 160. In additional or alternative embodiments, the virtual meeting 160 can be an audio-based virtual meeting, which includes a meeting during which a client device 102 captures and transmits audio streams (e.g., without generating and/or transmitting image streams) to other client devices 102 connected to platform 120. In some instances, a virtual meeting can include or otherwise be referred to as a conference call. In such instances, a video-based virtual meeting can include or otherwise be referred to as a video-based conference call and an audio-based virtual meeting can include or otherwise be referred to as an audio-based conference call.

The client devices 102A-N can each include computing devices such as personal computers (PCs), laptops, mobile phones, smart phones, tablet computers, netbook computers, network-connected televisions, etc. In some implementations, client devices 102A-N may also be referred to as “user devices.” A client device 102 can include an audiovisual component that can generate audio and video streams to be transmitted to conference platform 120. In some implementations, the audiovisual component can include one or more devices (e.g., a microphone, etc.) that capture an audio stream representing audio provided by the user. The audiovisual component can generate audio data (e.g., an audio file) based on the captured audio stream. In some embodiments, the audiovisual component can additionally or alternatively include one or more devices (e.g., a speaker) that output data to a user associated with a particular client device 102. In some embodiments, the audiovisual component can additionally or alternatively include a video capture device (e.g., a camera) to capture videos streams and generate video data (e.g., a video file) based on the captured video streams.

In some embodiments, one or more client devices 102 can be devices of a physical conference room or a meeting room. Such client devices 102 can be included at or otherwise coupled to a media system 132 that includes one or more display devices 136, one or more speakers 140 and/or one or more cameras 142. A display device 136 can be, or otherwise include, a smart display or a non-smart display (e.g., a display that is not itself configured to connect to platform 120 or other components of system 100 via network 104). Users that are physically present in the conference room or the meeting room can use a media system 132 rather than their own client devices 102 to participate in a virtual meeting, which may include other remote participants. For example, participants in the conference room or meeting room that participate in the virtual meeting may use display device 136 to share a slide presentation with, or watch a slide presentation of, other participants that are accessing the virtual meeting remotely. Sound and/or camera control can similarly be performed. As described above, a client device 102 connected to the media system 132 can generate media streams (e.g., audio and video streams) to be transmitted to platform 120 (e.g., using one or more microphones (not shown), speaker(s) 140 and/or camera(s) 142).

Client devices 102A-N can each include a content viewer, in some embodiments. In some implementations, a content viewer can be an application that provides a user interface (UI) (sometimes referred to as a graphical user interface (GUI)) for users to access the virtual meeting 160 hosted by platform 120. The content viewer can be included in a web browser and/or a client application (e.g., a mobile application, a desktop application, etc.). In one or more examples, a user of client device 102A can join and participate in the virtual meeting 160 via UI 124A presented via display 103A via the web browser and/or client application. A user can also present or otherwise share a document to other participants of the virtual meeting 160 via each of UIs 124A-124N. Each of UIs 124A-124N can include multiple regions that enable presentation of visual items corresponding to video streams of client devices 102A-102N provided to platform 120 during the virtual meeting 160.

In some embodiments, platform 120 can include a virtual meeting manager 152. Virtual meeting manager 152 can be configured to manage the virtual meeting 160 between two or more users of platform 120. In some embodiments, the virtual meeting manager 152 can provide the UI 124 to each of client devices 102 to enable users to watch and listen to each other during a video conference. The virtual meeting manager 152 can also collect and provide data associated with the virtual meeting 160 to each participant of the virtual meeting 160. For example, the virtual meeting manager 152 can provide documents that are associated with the virtual meeting 160 to one or more participants of the virtual meeting 160.

Platform 120 can additionally or alternatively include a transcription engine 154 that generates a transcript based on a discussion between participants of a virtual meeting 160. An engine, as described herein, refers to a component of a system (e.g., system 100) that powers and drives one or more functionalities of the system. An engine can be a software engine that includes or otherwise corresponds to a core program or set of operations that drive specific functionality within a system or application and/or a hardware engine that includes or otherwise corresponds to a physical component designed to perform specialized tasks. In some embodiments, transcription engine 154 can be an engine that is designed or otherwise configured to generate a transcript reflecting verbal statements and/or textual statements provided by participants during a virtual meeting 160.

In some embodiments, transcription engine 154 can generate a transcript by translating audio signal(s) collected by client device(s) 102 into a textual representation of the verbal statements provided during the discussion of the virtual meeting 160. For example, transcription engine 154 can perform one or more audio input processing operations to refine an audio signal (e.g., remove background noise, normalize volume, enhance speech clarity, etc.). The transcription engine 154 may then provide the refined audio signal as an input to one or more AI models that are trained to perform speech recognition operations (e.g., analyze audio signals to recognize and interpret human speech) and/or language modeling operations (e.g., predict a likely sequence of words or phrases based on grammar, context, and known vocabulary). The transcription engine can obtain one or more outputs of the AI models, which can include a textual representation of one or more verbal statements included in the audio signal. It should be noted that although some embodiments and examples of the present disclosure refer to AI-based transcript generation techniques, transcription engine 154 can generate the transcript in accordance with other techniques.

In some embodiments, transcription engine 154 can generate a live transcript of the discussion by processing audio signals collected by client device(s) 102 in real time (or approximately real time). Transcription engine 154 can provide the live transcript for presentation to participants of virtual meeting 160 via a UI 124, in some embodiments. In some embodiments, the live transcript can be continuously updated as participants continue a discussion of the virtual meeting 160. In other or similar embodiments, transcription engine 154 can generate a post-meeting transcript based on a recorded audio file or video file of the virtual meeting 160. The post-meeting transcript may reflect the entire conversation or discussion of the virtual meeting 160. In some embodiments, transcription engine 154 may generate the post-meeting transcript based on the live transcript, which is generated during the virtual meeting 160. For example, upon completion of the virtual meeting 160, transcription engine 154 may perform one or more transcript processing operations (e.g., speaker diarization operations, noise filtering operations, punctuation operations, etc.) to the live transcript generated throughout the virtual meeting 160.

As illustrated in FIG. 1, in some embodiments, platform 120 can additionally or alternatively include a meeting resource engine 156. Meeting resource engine 156 can generate or otherwise update a meeting resource associated with a virtual meeting 160. A meeting resource refers to meeting minutes (e.g., a record of points, discussions, and action items) for virtual meeting 160, a meeting summary (e.g., a high level summarization of topics discussed, key outcomes and decisions, and/or action items, etc.) for the virtual meeting 160, tasks associated with action items of the virtual meeting 160, and so forth. In some embodiments, meeting resource engine 156 generate an electronic document (e.g., a word processing document, a spreadsheet document, a slide presentation document, an electronic message document, etc.) that includes one or more meeting resources and can update the electronic document in accordance with a discussion of the virtual meeting 160. Meeting resource engine 156 can provide the electronic document (or one or more meeting resources of the electronic document) for presentation to a participant of the virtual meeting 160 (or another user of platform 120 that did not attend the virtual meeting 160) via a UI 124 of a client device 102. For example, meeting resource engine 156 can provide the electronic document and/or the meeting resource(s) for presentation via a UI for the virtual meeting 160 and/or via a UI for another application of platform 120 (e.g., after completion of the virtual meeting 160).

In some embodiments, meeting resource engine 156 may generate or otherwise update a meeting resource upon determining that an “automated meeting resource” functionality is enabled for the virtual meeting 160. In some embodiments, a participant of virtual meeting 160 can enable the automated meeting resource functionality by engaging with one or more UI elements of the virtual meeting UI. In other or similar embodiments, meeting resource engine 156 may detect a request (e.g., a verbal request, a textual request, etc.) to initiate the automated meeting resource functionality during a discussion between participants of the virtual meeting.

In some embodiments, upon detecting that the automated meeting resource functionality is initiated, meeting resource engine 156 can generate a prompt associated with operations requested by participants of the virtual meeting 160 and, in some embodiments, can provide the generated prompt as an input to one or more AI model(s) 182, which are trained to perform the actions. In some embodiments, AI model(s) 182 can include one or more large language models that are trained to perform tasks or operations associated with a virtual meeting 160. The operations can include or otherwise correspond to preparing meeting minutes associated with the virtual meeting 160, preparing a meeting summary associated with the virtual meeting 160, generating tasks out of action items corresponding to one or more discussion points of a transcript (e.g., a live transcript or a post-meeting transcript), storing meeting notes associated with the virtual meeting 160 for later reference (e.g., at data store 110), presenting an electronic document via a UI 124 of a client device 102 of a participant, or generating a response to a question of a participant, and so forth. In some embodiments, the meeting resource can include a meeting overview or a meeting summary that is organized and/or categorized in accordance with topics of discussion by participants of virtual meeting 160 and/or one or more characteristics of the participants of virtual meeting 160. Further detail regarding generating such meeting resources are provided herein.

It should be noted that although FIG. 1 illustrates the virtual meeting manager 152, transcription engine 154, and/or meeting resource engine 156 as part of platform 120, in additional or alternative embodiments, virtual meeting manager 152, transcription engine 154, and/or meeting resource engine 156 can reside on one or more server machines that are remote from platform 120 (e.g., server machine(s) 150). It should be noted that in some other implementations, the functions of platform 120, server machine(s) 150 and/or predictive system 180 can be provided by more or a fewer number of machines. For example, in some implementations, components and/or modules of platform 120, server machine(s) 150 and/or predictive system 180 may be integrated into a single machine, while in other implementations components and/or modules of any of platform 120, server machine(s) 150 and/or predictive system 180 may be integrated into multiple machines. In addition, in some implementations, components and/or modules of server machine(s) 150 and/or predictive system 180 may be integrated into platform 120.

In general, functions described in implementations as being performed by platform 120, server machine(s) 150, and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces.

Although implementations of the disclosure are discussed in terms of platform 120 and users of platform 120 accessing the virtual meeting 160 hosted by platform 120, implementations of the disclosure are not limited to conference platforms and can be extended to any type of virtual meeting.

In implementations of the disclosure, a “user” can be represented as a single individual. However, other implementations of the disclosure can describe a “user” as an entity controlled by a set of users and/or an automated source. For example, a set of individual users federated as a community in a social network can be considered a “user.” In another example, an automated consumer can be an automated ingestion pipeline of platform 120.

In situations in which the systems discussed here collect personal information about users, or can make use of personal information, the users can be provided with an opportunity to control whether the platform 120, virtual meeting manager 152, transcription engine 154, and/or meeting resource engine 156 collects user information (e.g., information about a user's social network, social actions or activities, profession, a user's preferences, or a user's current location), or to control whether or how to receive content from the virtual meeting platform 120 or the virtual meeting manager 152 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 152.

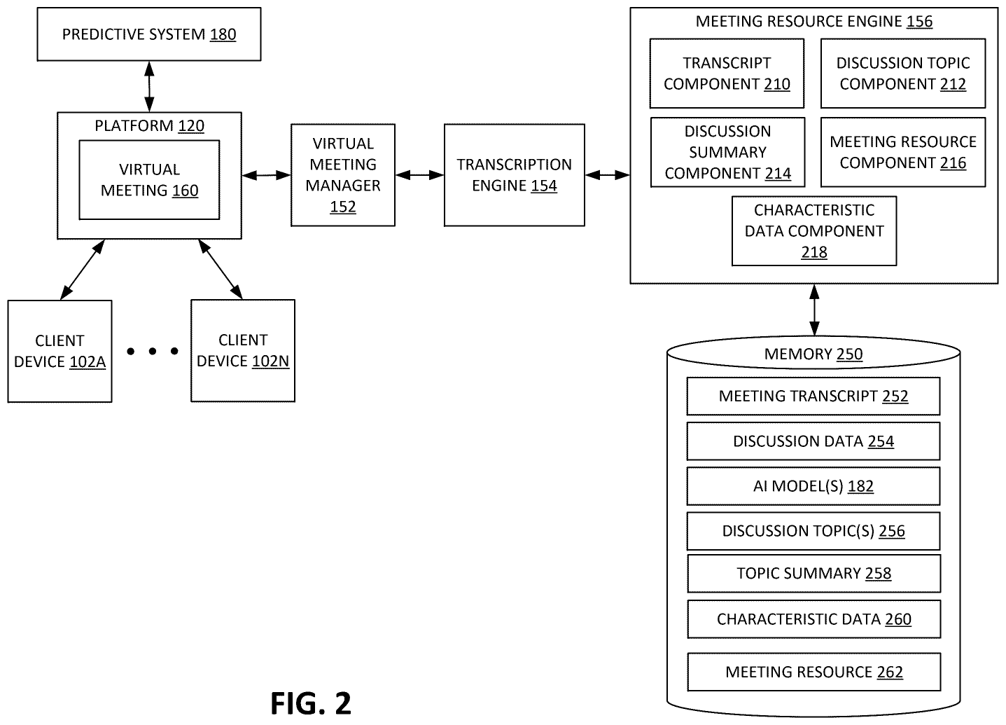

FIG. 2 is a block diagram of an example meeting resource engine 156, in accordance with implementations of the present disclosure. As described above, platform 120 can provide users with access to tools and functionalities associated with a virtual meeting 160. For example, a user of client device 102A can participate in a virtual meeting 160 with other users (e.g., of client devices 102B-N) via one or more tools or functionalities provided by platform 120). Meeting resource engine 156 can generate or otherwise update meeting resource(s) 262 associated with virtual meeting 160. A meeting resource 262 can include meeting minutes of the virtual meeting 160, a meeting summary for the virtual meeting 160, a meeting overview for the virtual meeting 160, a task for an action item discussed during the virtual meeting 160, and so forth. Meeting resource engine 156 can perform additional or alternative operations associated with a virtual meeting 160, in some embodiments. For example, meeting resource 262 can perform operations such as preparing meeting minutes associated with the virtual meeting 160, preparing a meeting summary associated with the virtual meeting 160, generating tasks out of action items corresponding to one or more discussion points of a transcript (e.g., a live transcript or a post-meeting transcript), storing meeting notes associated with the virtual meeting 160 for later reference (e.g., at data store 110), presenting an electronic document via a UI 124 of a client device 102 of a participant, or generating a response to a question of a participant, and so forth.

In some embodiments, meeting resource engine 156 can perform the operations described above based on one or more outputs of an AI model 182. As described herein, AI model 182 refers to a model (e.g., a LLM) that is trained to perform operations pertaining to a virtual meeting 160. As will be seen below, other types of AI models are used or otherwise accessed by meeting resource engine 156. Although such models are also AI models, AI model 182, as described herein, is intended to refer to a model that is trained to perform operations pertaining to the virtual meeting 160. Such other models are referred to directly and individually, as seen below.

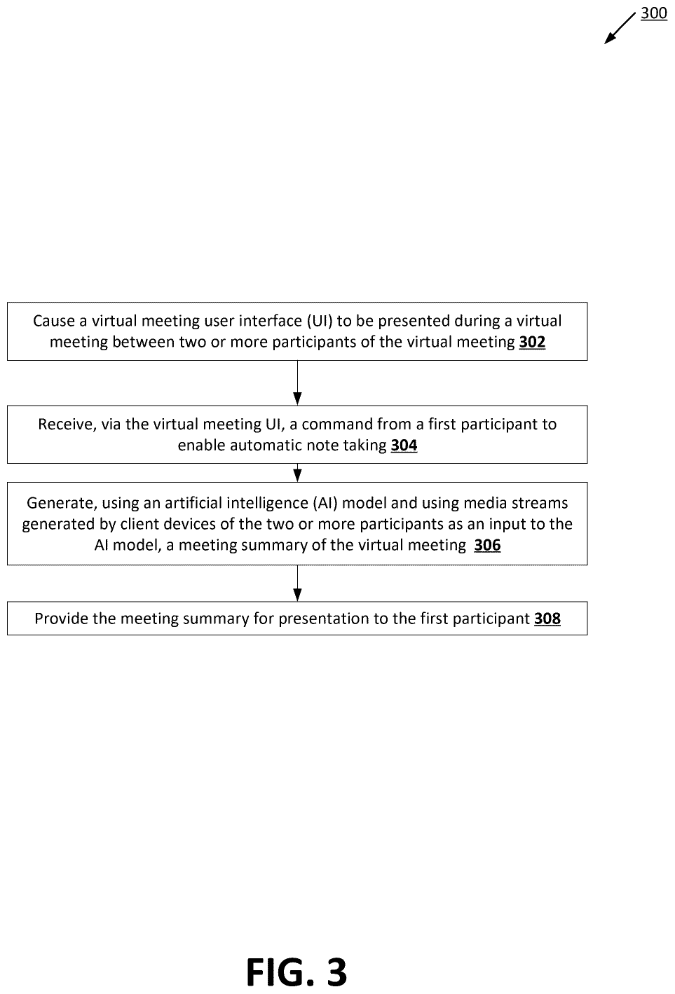

FIG. 3 depicts a flow diagram of an example method 300 for operation(s) performed by meeting resource engine 156 (e.g., generating a meeting summary of a virtual meeting 160), in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by meeting resource engine 156.

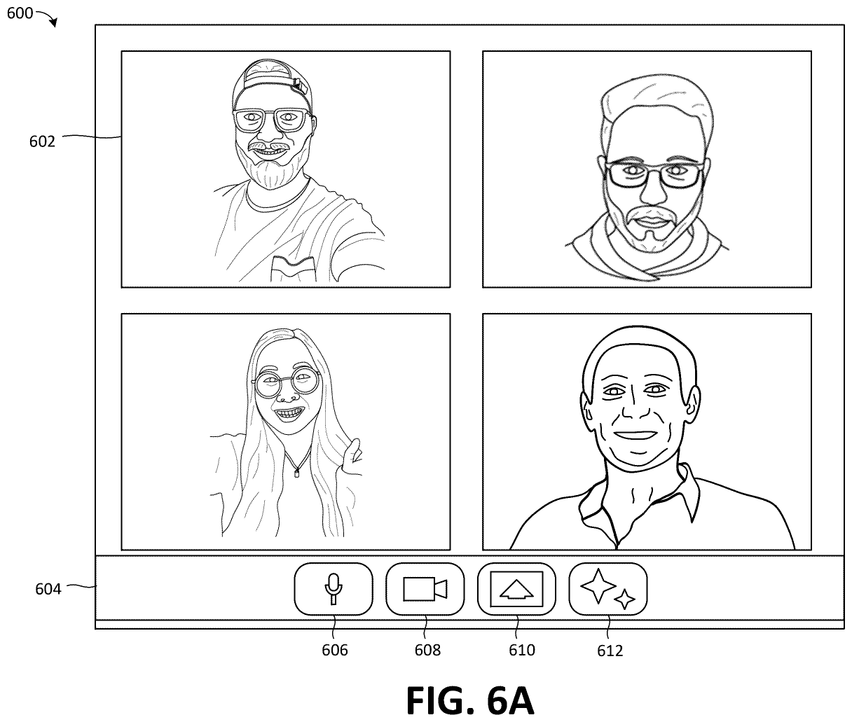

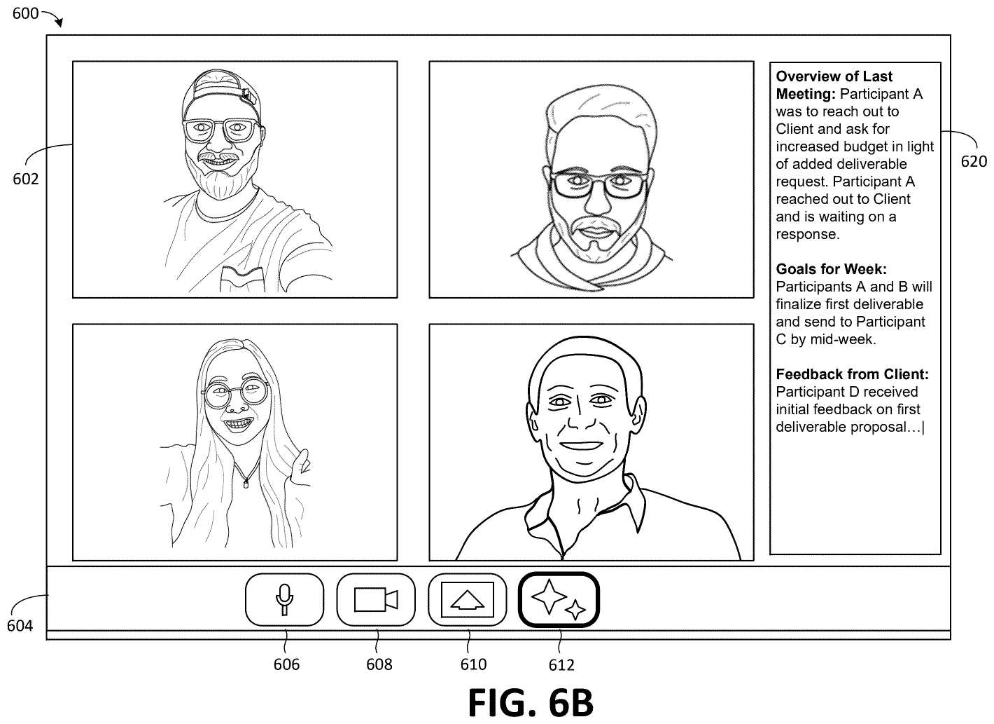

At block 302, processing logic causes a virtual meeting UI to be presented during a virtual meeting between two or more participants of the virtual meeting. As described herein, platform 120 can enable users to connect with other users (e.g., participants) of a virtual meeting 160 via tools or functionalities of platform 120. FIG. 6A illustrates an example virtual meeting UI 600 presented during a virtual meeting 160 via client device(s) 102 of two or more participants. As illustrated by FIG. 6A, the UI can include one or more regions 602 corresponding to a visual item of the virtual meeting 160, such as a video stream provided by a client device 102A-N of a participant of the virtual meeting 160. The virtual meeting UI 600 can include a tool bar 604 that includes one or more UI elements associated with virtual meeting operations. For example, as seen in FIG. 6, the tool bar 604 includes an audio control element 606 (e.g., that enables a participant to mute and unmute their audio stream), a camera control element 608 (e.g., that enables a participant to mute and unmute their video stream), and/or a screen share element 610 (e.g., that enables a participant to initiate a screen sharing operation to share a view of a client device 102 with other participants of the virtual meeting 122). In some embodiments, the tool bar 604 may include one or more UI elements 612 that enable a participant to initiate an automated meeting resource functionality, as described herein.

Referring back to FIG. 3, at block 304, processing logic receives, via the virtual meeting UI, a command from a first participant to enable automatic note taking. In some embodiments, a participant can engage with UI element 612 of UI 600 to provide a request to initiate the automated meeting resource functionality. As described above, the automated meeting resource functionality can involve or otherwise include generating or preparing meeting notes or a meeting summary based on a discussion of virtual meeting 160. A client device 102 associated with the participant can detect the engagement with the UI element 612 and can provide a notification of the detection to platform 120. Platform 120 can provide the notification to meeting resource engine 156, where the provided notification includes or otherwise corresponds to a command from the first participant to enable automatic note taking. In additional or alternative embodiments, a participant of virtual meeting 160 can provide the command in accordance with other techniques. For example, the participant can provide a verbal command and/or a text command (e.g., via a chat window of UI 600) to initiate the automated meeting resource functionality. Transcription engine 154 can generate a transcript of the virtual meeting 160 including the verbal command and/or the text command. Meeting resource engine 156 can identify the verbal command and/or the text command based on the generated transcript, in some embodiments. In yet additional or alternative embodiments, a participant of a virtual meeting 160 can engage with one or more other UI elements of FIG. 6A (elements that are illustrated or not illustrated) and meeting resource engine 154 may initiate the automated meeting resource functionality based on a detection of the engagement with the other UI elements. For example, a participant may engage with a UI element (not shown) associated with initiating a recording operation to generate an audio and/or video-based recording of the virtual meeting. Upon detecting the engagement, platform 120 can update the UI 600 to include an inquiry as to whether the participant would also like to initiate the automated meeting resource functionality and may initiate the functionality based on a user provided response to the inquiry.

At block 306, processing logic generates, using an AI model and using media streams generated by client devices of the two or more participants as an input to the AI model, a meeting summary of the virtual meeting. As described herein, meeting resource engine 154 may generate one or more prompts for the AI model based on a discussion of the participants during the virtual meeting 160. Meeting resource engine 154 can provide the generated prompt(s) as an input to the AI model to cause the AI model to perform operations associated with the virtual meeting 160. In accordance with the example of FIG. 3, the prompt(s) can correspond to or otherwise pertain to operations associated with generating the meeting summary of the virtual meeting 160. Upon providing the prompt(s) as an input to the AI model, meeting resource engine 154 can obtain one or more meeting resources (e.g., a summarization of the discussion points) as an output to the AI model.

At block 308, processing logic provides the meeting summary for presentation to the first participant. In some embodiments, meeting resource engine 154 can update UI 600 to present an obtained meeting resource (e.g., the meeting summary) to the participants of the virtual meeting 160 as the virtual meeting is being conducted. As illustrated by FIG. 6B, meeting resource engine 154 can update UI 600 to include the meeting summary generated by the AI model in an additional region 620 of UI 600.

Referring back to FIG. 2, meeting resource engine 156 can include a transcript component 210, a discussion topic component 212, a topic summary component 214, and/or a characteristic data component 216. Details regarding components of meeting resource engine 156 are provided herein with respect to FIG. 2 and FIGS. 4-8. Platform 120, predictive system 180, virtual meeting manager 152, transcription engine 154, and/or meeting resource engine 156 can be connected to a memory 250 (e.g., via network 104, via a bus, etc.). Memory 250 can include one or more portions of data store 110, in some embodiments. In other or similar embodiments, memory 250 can include or correspond to any memory of any component of system 100 and/or otherwise accessible to a component of system 100.

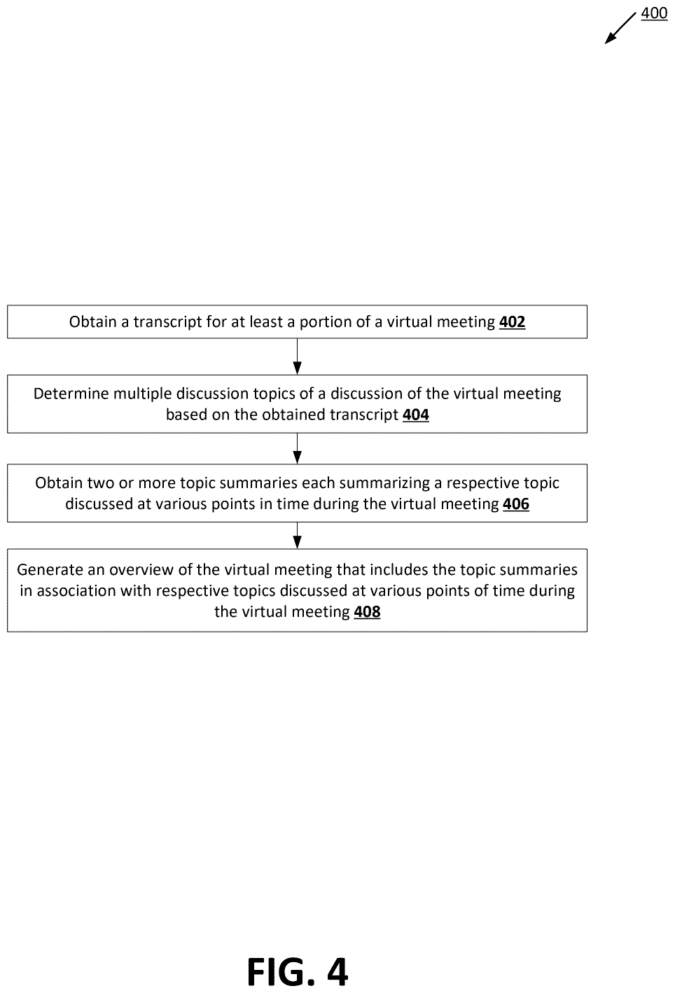

As described herein, meeting resource engine 156 can generate a meeting resource (e.g., a meeting summary, a meeting overview, etc.) that includes multiple topic summaries organized in association with topics discussed at various points of time during a virtual meeting 160. FIG. 4 depicts a flow diagram of an example method 400 for customizing an organization or categorization of a meeting resource based on a meeting discussion, in accordance with implementations of the present disclosure. Method 400 can be performed by processing logic that can include hardware (circuitry, dedicated logic, etc.), software (e.g., instructions run on a processing device), or a combination thereof. In one implementation, some or all the operations of method 400 can be performed by one or more components of system 100 of FIG. 1. In some embodiments, some or all of the operations of method 400 can be performed by meeting resource engine 156.

At block 402, processing logic obtains a transcript for at least a portion of a virtual meeting. In some embodiments, The meeting transcript 252 can be a live transcript or a post-meeting transcript. As described above, a live transcript includes current content discussed by participants of a virtual meeting 160 and is generated in real-time (or approximately real-time) during the virtual meeting 160. A post-meeting transcript includes all content (or at least a portion of the content) discussed by participants during the virtual meeting 160 and is generated after completion of the virtual meeting 160. Virtual meeting manager 152 (or another component of platform 120) can obtain discussion data 254 from one or more client devices 102 of participants of virtual meeting 160. The discussion data 254 can include audio signals generated by client device(s) 102 that represent verbal statements provided by the participants, in some embodiments. In other or similar embodiments, the discussion data 254 can include textual data or other such type of data indicating textual statements of the participants. For example, two or more participants can participate in a chat discussion (e.g., via a chat functionality) during the virtual meeting 160. Discussion data 254 can include content and/or other metadata (e.g., time stamps, participant identifiers, etc.) associated with the chat discussion. Virtual meeting manager 152 can obtain the discussion data 254 and provide the discussion data 254 to transcription engine 154 and/or can store the discussion data 254 at memory 250.

Transcription engine 154 can generate a transcript representing content of a discussion between participants of the virtual meeting 160, as described above. In some embodiments, transcription engine 154 can generate a live transcript, which reflects current content and/or prior content of the discussion between an initial time period of the virtual meeting 160 (e.g., when the virtual meeting 160 was started or scheduled to start) and a current time period of the virtual meeting 160. Transcription engine 154 can store the live transcript at memory 250 as meeting transcript 252, in some embodiments. In some embodiments, transcription engine 154 can update the meeting transcript 252 (e.g., continuously or periodically according to a transcription schedule defined for platform 120) based on the discussion throughout the virtual meeting 160. In other or similar embodiments, transcription engine 154 can generate a post-meeting transcript based on the discussion data 254 collected for the entire virtual meeting 160 (or at least a portion of the virtual meeting 160) and/or based on the live transcript generated and updated throughout the virtual meeting 160. In some embodiments, transcription engine 154 can perform one or more post-processing operations associated with the live transcript, as described above, to generate the post-meeting transcript. Transcription engine 154 can store the post-meeting transcript at memory 250 as meeting transcript 252, as described above. Transcript component 210 can receive the meeting transcript 252 from transcription engine 154 and/or can retrieve meeting transcript 252 from memory 250.

At block 404, processing logic determines multiple discussion topics of a discussion of a virtual meeting based on the obtained transcript. A discussion topic refers to a subject or point of focus that is addressed by participants during a virtual meeting, and can represent a unit of conversation centered around a specific issue, decision, update, or question relevant to the meeting's purpose. In some embodiments, discussion topic component 212 can determine a discussion topic by providing meeting transcript 252 (or a portion of meeting transcript 252) as an input to an AI model 182 and obtaining one or more outputs of the AI model 182, which can include an indication of the set of discussion topics. The AI model 182 (referred to herein as a discussion topic model) may be a natural language processing (NLP) model that is trained to predict a set of discussion topics of the virtual meeting 160 (or a portion of the virtual meeting 160) in view of the given transcript 252. In some embodiments, the discussion topic model can include a Latent Dirichlet Allocation (LDA) model, a Non-negative Matrix Factorization (NMF) model, a fine-tuned Bidirectional Encoder Representations from Transformers (BERT) model, and so forth.

In some embodiments, discussion topic component 212 can provide meeting transcript 252 as an input to the discussion topic model and obtain one or more outputs of the discussion topic model. In some embodiments, the output(s) can include a set of discussion topics 256 and, for each discussion topic, an indication of a portion of meeting transcript 252 corresponding to the respective discussion topic. As described above, a discussion topic 256 may be discussed by participants multiple times throughout the virtual meeting 160. Accordingly, the output(s) of the discussion topic model can include an indication of multiple portions (e.g., adjacent portions or non-adjacent portions) of meeting transcript 252 corresponding to the respective discussion topic. In other or similar embodiments, the output(s) can include, for each of the set of discussion topics 256, an indication of a level of confidence that a portion of the meeting transcript 252 corresponds to the respective discussion topic 256. In some embodiments, discussion topic component 212 can identify discussion topics 256 of the output(s) having a level of confidence that satisfies one or more confidence criteria (e.g., exceeds a threshold level of confidence, is larger than levels of confidence for other discussion topics 256, etc.). Discussion topic component 212 may store the set of discussion topics at memory 250 as discussion topic(s) 256.

At block 406, processing logic obtains two or more topic summaries each summarizing a respective topic discussed at various points in time during the virtual meeting. In some embodiments, discussion summary component 214 can provide at least a portion of meeting transcript 252 as an input to an AI model 182 and obtain one or more outputs that include a summary of portions of transcript 252 that correspond to a respective discussion topic 256. The AI model 182 (referred to as a summary generator model) can include a generating AI model that is trained to generate content based on a request and/or data included in a given prompt. In some embodiments, discussion summary component 214 can provide the set of discussion topics 256 as an additional input to the summary generator model. In other or similar embodiments, discussion summary component 214 can provide an indication of one or more regions of meeting transcript 252 that correspond to each respective discussion topic 256 (e.g., as indicated by output(s) of the discussion topic model) as an input to the summary generator model. In yet other or similar embodiments, discussion summary component 214 can provide the sections of meeting transcript 252 that are indicated to correspond to a respective discussion topic 256 (e.g., without including other portions or sections of meeting transcript 252) as an input to the summary generator model. Discussion summary component 214 can obtain one or more outputs of the summary generator model, which can include a summary of content of transcript 252 pertaining to each respective topic 256. In an illustrative example, participants of virtual meeting 160 can discuss topic A at time period T0, time period T5, and time period T10 of the virtual meeting 160. The output(s) of the summary generator model can include a summary of the content pertaining to topic A, as discussed at time periods T0, T5, and T10. In some embodiments, discussion summary component 214 can store the summary for each topic 256 at memory 250 as a topic summary 258.

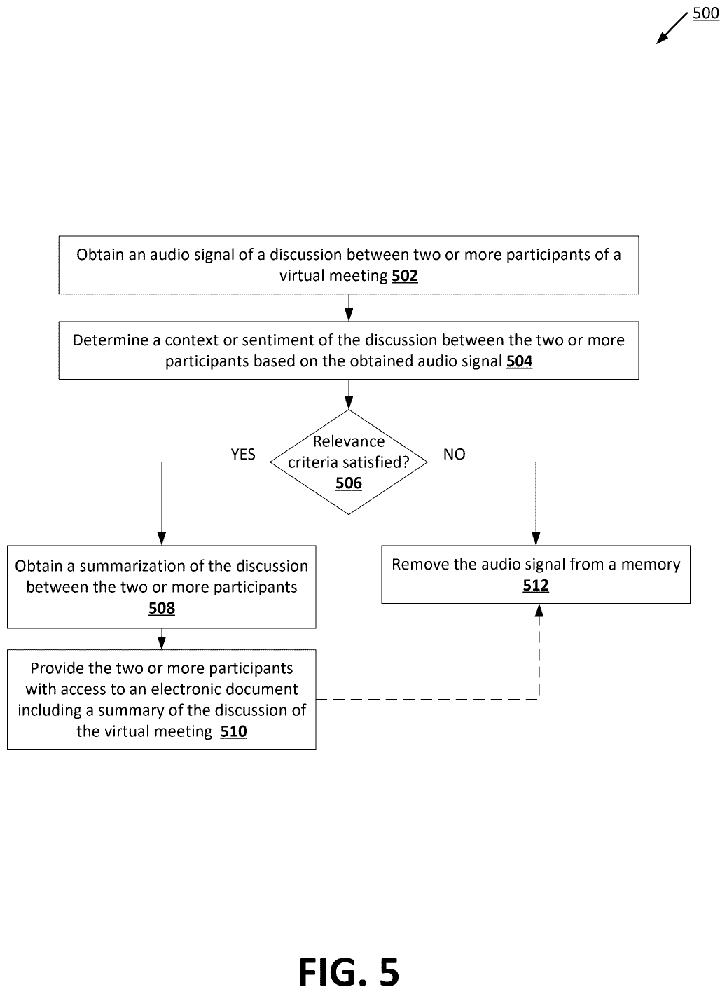

In some instances, a portion of transcript 252 that includes content pertaining to a particular topic 256 may also include content that does not pertain to the topic 256. For example, as reflected by meeting transcript 252, during an initial time period of virtual meeting 160, Participant A and Participant B may discuss a particular topic and Participant C may join the virtual meeting 160 during such time period. The discussion of the topic may be interrupted, as Participant C greets the other participants, apologizes for being late to the meeting, and so forth. Participant A, Participant B, and Participant C may then continue the discussion of the topic. In some embodiments, discussion summary component 214 may identify content of meeting transcript 252 associated with the initial time period that is relevant to the particular topic, as described with respect to FIG. 5 below. Discussion summary component 214 may generate the topic summary 258 for the topic 256 based on such content, as described herein.

FIG. 5 depicts a flow diagram of an example method 500 for identifying relevant discussion points of a virtual meeting, in accordance with implementations of the present disclosure. Method 500 can be performed by processing logic that can include hardware (circuitry, dedicated logic, etc.), software (e.g., instructions run on a processing device), or a combination thereof. In one implementation, some or all the operations of method 500 can be performed by one or more components of system 100 of FIG. 1. In some embodiments, some or all of the operations of method 500 can be performed by meeting resource engine 156 (e.g., by discussion summary component 214 of meeting resource engine 156).

At block 502, processing logic obtains an audio signal of a discussion between two or more participants of a virtual meeting. The audio signal can be collected by client device(s) 102 of participants of virtual meeting 160. In some embodiments, transcription engine 154 may generate a meeting transcript 252 (e.g., a live transcript, a post-meeting transcript, etc.) based on the obtained audio signal, in accordance with previously described embodiments.

At block 504, processing logic determines a context or sentiment of a discussion between two or more participants based on the obtained audio signal. A context refers to a background, topic, or issue being addressed during the virtual meeting discussion in a time period prior to or when a discussion point was presented by a participant of virtual meeting 160. The context can include, but is not limited to, a relevant part of the discussion, the participants involved, goals or challenges discussed, any decisions or agreements discussed, and so forth. A sentiment refers to the emotional tone or attitude conveyed by the participant when the discussion point was made. A sentiment may be neutral, positive (e.g., expressed with enthusiasm or agreement), urgent (e.g., reflecting time-sensitivity or importance), and so forth. In some instances, the sentiment of the request can indicate the priority behind the discussion point and/or how it should be addressed or followed up.

In some embodiments, discussion summary component 214 can determine the context or sentiment of the discussion by providing meeting transcript 252 (or a portion of meeting transcript 252) as an input to a discussion context model. In some embodiments, the discussion context model can be an NLP model that is trained to predict a context and/or a sentiment of given input data. In some embodiments, discussion summary component 214 can provide meeting transcript 252 as an input to the discussion context model (or can provide a portion of meeting transcript 252). Discussion summary component 214 can obtain one or more outputs of the discussion context model, which can indicate a predicted context and/or a predicted sentiment of the discussion.

At block 506, processing logic determines whether the context of the discussion satisfies one or more relevance criteria. In some embodiments, discussion summary component 214 can provide the content of at least a portion of transcript 252, the determined context or sentiment of the content (e.g., as obtained according to block 504), and/or an indication of the set of discussion topics 256 as an input to an AI model 182 (referred to herein as a topic relevance model) that is trained to predict a degree of relevance between given content and a respective topic in view of a context or a sentiment of the topic. Discussion summary component 214 can obtain one or more outputs of the topic relevance model, which can include a degree of relevance between the content of the at least the portion of transcript 252 to at least one of discussion topic(s) 256 in view of the determined context and/or sentiment of the content. In other or similar embodiments, the degree of relevance can be included in the output(s) of the discussion context model, as described above. In some embodiments, discussion summary component 214 can determine whether the context of the discussion pertaining to the content of the at least the portion of meeting transcript 252 satisfies the relevance criteria by determining whether the degree of relevance meets or exceeds a threshold value.

Responsive to a determination that the context of the discussion satisfies the one or more relevance criteria (e.g., that the degree of relevance meets or exceeds the threshold value), method 500 proceeds to block 508. At block 508, processing logic obtains a summarization of the discussion between the two or more participants. In some embodiments, upon determining that the relevance criteria are satisfied, discussion summary component 214 can provide the content of the at least the portion of meeting transcript 252 as an input to the summary generator model, as described above. At block 510, processing logic provides the two or more participants with access to an electronic document including a summary of the discussion of the virtual meeting. The electronic document can include a meeting resource 262, as described below. Responsive to a determination that the context of the discussion does not satisfy the one or more relevance criteria (e.g., that the degree of relevance falls below the threshold value), method 500 proceeds to block 512. At block 512, processing logic removes the audio signal from a memory (e.g., memory 250, a memory of client device 102, another memory of or accessible to system 100, etc.). In some embodiments, upon providing the two or more participants with access to the electronic document including the summary of the discussion of the virtual meeting, method 500 can, optionally, proceed to block 512, where the audio signal associated with the summary is removed from the memory, as described above.

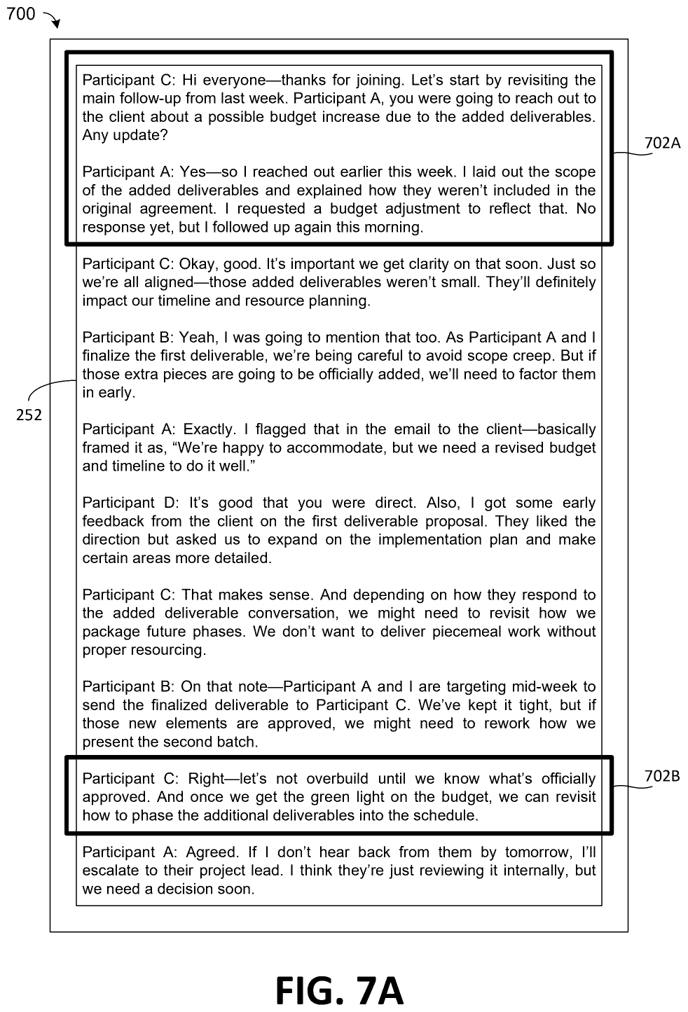

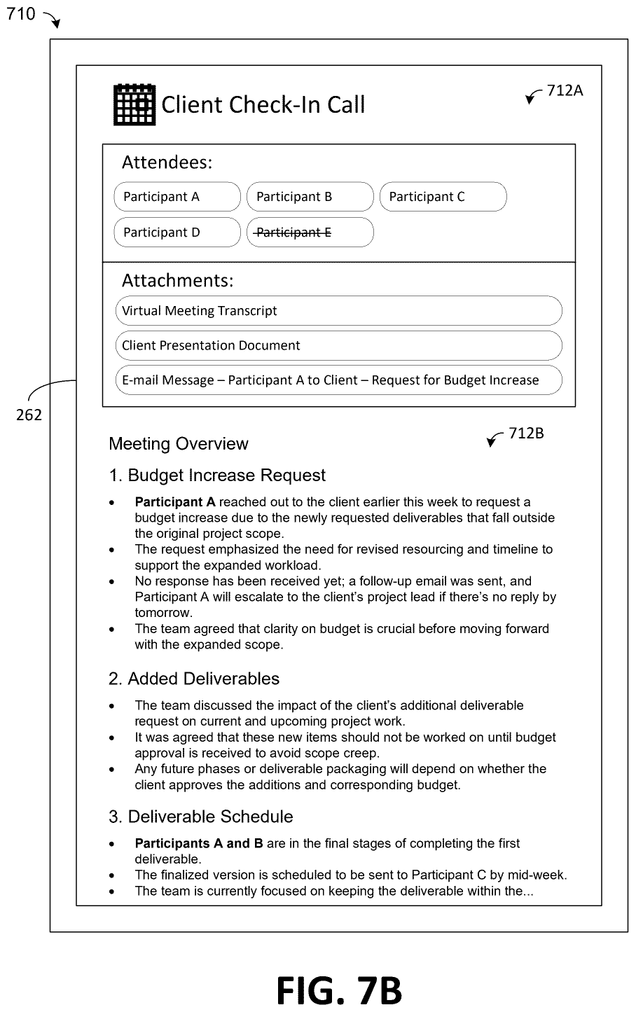

Referring back to FIG. 4, at block 408, processing logic generates an overview of the virtual meeting that includes the topic summaries in association with respective topics discussed at various points of time during the virtual meeting. In some embodiments, meeting resource component 216 can generate the meeting resource 262, which includes the overview (e.g., the overall summary) of virtual meeting 160. The meeting resource 262 can include the topic summaries 258 obtained by discussion summary component 214 in association with respective discussion topics 256 identified by discussion topic component 212. In some embodiments, meeting resource component 216 can generate the meeting resource 262 by providing the discussion topic(s) 256 and/or the topic summaries as an input to an AI model 182 (e.g., a meeting resource generator model) that is trained to generate meeting resources 262 based on given data. The meeting resource model can be a generative AI model, as described herein. An example of the meeting resource 262 including the overview of the virtual meeting 160 that includes the topic summaries 258 in association with respective topics 256 generated by the meeting resource generator model is provided with respect to FIGS. 7A-7B.

FIG. 7A illustrates an example UI 700 depicting a portion of meeting transcript 252. As illustrated by FIG. 7A, section 702A of meeting transcript 252 indicates a discussion between Participant C and Participant A of the topic of the potential budget increase due to added deliverables from the client. Section 702B indicates that Participant C revisited the discussion on the budget increase at a later time period during the virtual meeting 160 (as indicated by transcript 252).

FIG. 7B illustrates an example UI 710 depicting a meeting resource 262 generated based on meeting transcript 252, as described herein. As illustrated by FIG. 7B, meeting resource 252 can include an overview of virtual meeting 160. A first section 712A of meeting resource 252 can include data or metadata associated with the virtual meeting 160, in some embodiments. For example, as illustrated by FIG. 7B, the first section 712A of meeting resource 252 can include an indication of a title or subject of the virtual meeting 160 (e.g., “Client Check-In Call”), an indication of one or more participants that attended the virtual meeting 160 (e.g., Participants A- D), an indication of one or more participants that were invited to but did not attend the virtual meeting 160 (e.g., Participant E), and so forth. The first section 712A can also include a reference (e.g., a link) to one or more electronic documents associated with the virtual meeting 160, including a document including the meeting transcript 252 and/or other documents presented during the virtual meeting 160 (e.g., “Client Presentation Document”) or otherwise associated with the virtual meeting 160. In some embodiments, meeting resource component 216 can identify the electronic documents presented during the virtual meeting 160 from a calendar event or a calendar invitation associated with the virtual meeting 160 and/or from a file store associated with one or more participants of virtual meeting 160.

Section 712B of meeting resource 262 can include the meeting summaries 258 associated with each respective topic 256 identified for the virtual meeting discussion, as described herein. For example, a first topic identified for the virtual meeting 160 can include “Budget Increase Request.” The meeting summary 258 generated for the first topic can be generated based on at least sections 702A and 702B of transcript 252, as described above.

In some embodiments, meeting resource component 216 can provide the meeting resource 262 for presentation to participants of virtual meeting 160 and/or users otherwise associated with virtual meeting 160 (e.g., users that were invited to virtual meeting 160 but did not attend). As described above, transcript 252 can be a live transcript that is generated as the virtual meeting is being conducted. In such embodiments, meeting resource 262 may also be generated as the virtual meeting is being conducted. Meeting resource component 216 can provide meeting resource 262 for presentation via the virtual meeting UI (e.g., at region 620 of UI 600), as described above). In some embodiments, participants of the virtual meeting 160 may revisit a particular discussion topic 256 during a later time period of the virtual meeting 160. Meeting resource engine 156 may update a generated topic summary 258 and/or meeting resource 262 based the discussion of the participants on the discussion topic 256 at the later time period and may provide the updated topic summary 258 and/or the updated meeting resource 262 for presentation via the virtual meeting UI, as described above. In other or similar embodiments, transcript 252 can be a post-meeting transcript. In such embodiments, meeting resource component 216 can provide participants and/or other users with access to meeting resource 262 via one or more other applications associated with platform 120 and/or system 100 (e.g., an electronic document application, a calendar application, an electronic mail application, etc.).

It should be noted that although embodiments and examples described above provide that multiple AI models 182 (e.g., a discussion topic model, a summary generator model, a discussion context model, a topic relevance model, a meeting resource generator model, etc.) are used to ultimately obtain meeting resource 262, in other or similar embodiments, the features and functionalities of such models 182 can be applied by or otherwise correspond to a single AI model 182. In other or similar embodiments, each of the multiple AI models 182 described herein can be included in a model pipeline associated with one or more multimodal models associated with platform 120 and/or system 100.

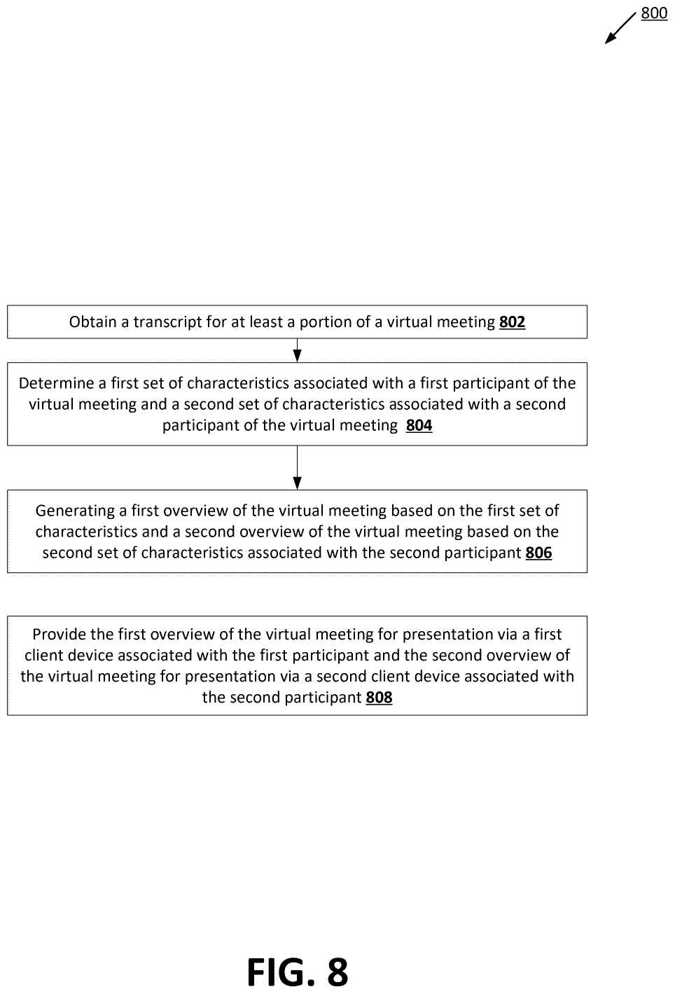

As discussed herein, in some embodiments, meeting resource engine 156 can generate multiple meeting resources 262 (e.g., multiple meeting summaries, multiple meeting overviews, etc.), where each meeting resource 262 is customized or otherwise distinct based on characteristics of participants of virtual meeting 160. FIG. 8 depicts a flow diagram of another example method 800 for customizing an organization or categorization of a meeting resource based on a meeting discussion, in accordance with implementations of the present disclosure. Method 800 can be performed by processing logic that can include hardware (circuitry, dedicated logic, etc.), software (e.g., instructions run on a processing device), or a combination thereof. In one implementation, some or all the operations of method 800 can be performed by one or more components of system 100 of FIG. 1. In some embodiments, some or all of the operations of method 800 can be performed by meeting resource engine 156.

At block 802, processing logic obtains a transcript for at least a portion of a virtual meeting. Transcript component 210 can obtain the meeting transcript 252 for virtual meeting 160 in accordance with previously described embodiments. At block 804, processing logic determines a first set of characteristics associated with a first participant of the virtual meeting and a second set of characteristics associated with a second participant of the virtual meeting. Example characteristics can include, but are not limited to, a role of a respective participant (e.g., in the meeting, in an organization, etc.), a position or title of the participant, an area of expertise of the participant (e.g., a technical expert, a business analyst, a financial representative, etc.), a relationship of the participant to the project or the topic, and so forth. In some embodiments, characteristic data component 218 of meeting resource engine 156 can determine characteristics associated with a participant based on data or metadata included in an account (e.g., for platform 120) associated with the participant. In other or similar embodiments, characteristic data component 218 can determine the characteristics associated with a participant based on a context or sentiment associated with content of transcript 252 (e.g., obtained in accordance with embodiments of FIG. 5). Upon determining the first set of characteristics and the second set of characteristics associated with the first and second participants, respectively, characteristic data component 218 can store the determined characteristics at memory 250 as characteristic data 260.

At block 806, processing logic generates a first overview of the virtual meeting based on the first set of characteristics and a second overview of the virtual meeting based on the second set of characteristics associated with the second participant. As described above, meeting resource component 216 can generate a meeting resource 262, which includes an overview of virtual meeting 160. In some embodiments, meeting resource component 216 can provide meeting transcript 252 (e.g., a live meeting transcript, a post-meeting transcript, etc.) and the characteristics data 260 for each participant as an input to an AI model 182 (e.g., a meeting resource generator model) and obtain one or more outputs, which includes the generated meeting resource. In other or similar embodiments, meeting resource engine 156 can determine topic(s) 256 of the virtual meeting discussion 256 and obtain the topic summaries 258 for each determined topic 256, as described above, and meeting resource can provide characteristic data 260 as an additional input to the meeting resource generator model. In the above-mentioned embodiments, the output(s) of the AI model 182 can include multiple meeting resources 262, which can include a first overview of the virtual meeting 160 and/or a second overview of the virtual meeting 160. The first overview of the virtual meeting 160 can have different summarized content, data, and/or metadata than the second overview of the virtual meeting 160, in view of the first set of characteristics associated with the first participant and the second set of characteristics associated with the second participant. In an illustrative example, the first participant may be a technical expert associated with a client's product and the second participant may be a business analyst. The first overview of the virtual meeting 160 can include summarized content, data, and/or metadata corresponding to the technical aspects of the client's product, while the second overview of the virtual meeting includes summarized content, data, and/or metadata corresponding to business objectives, financial matters, etc. associated with the client.

At block 808, processing logic provides the first overview of the virtual meeting for presentation via a first client device associated with the first participant and the second overview of the virtual meeting for presentation via a second client device associated with the second participant. In some embodiments, meeting resource component 216 can provide a meeting resource 262 including the first overview to a first client device (e.g., client device 102A) associated with the first participant and another meeting resource 262 including the second overview to a second client device (e.g., client device 102B) associated with the second participant. In some embodiments, meeting resource component 216 can provide the meeting resource(s) 262 for presentation during the virtual meeting 160 (e.g., via UI 600), as described above, or after completion of the virtual meeting 160.

Characteristic data 260 can include additional or alternative information associated with participants of virtual meeting 160, in some embodiments. For example, characteristic data 260 can include a meeting resource style preference or a meeting resource format preference of a particular participant (e.g., as defined by or otherwise determined for the participant). In an illustrative example, an organizer participant of the virtual meeting 160 (e.g., the participant that coordinates and/or schedules the virtual meeting 160) can define, at the time of coordination or scheduling) the style or format for the meeting resource 262 generated based on the discussion of virtual meeting 160. The organizer participant can define the style or format using one or more meeting resource configuration tools provided via a UI to a client device 102. In some embodiments, the style or format for the meeting resource 262 generated for each participant of virtual meeting 160 can correspond to the defined style or format and/or can correspond to the style or format associated or otherwise preferred by such participant.

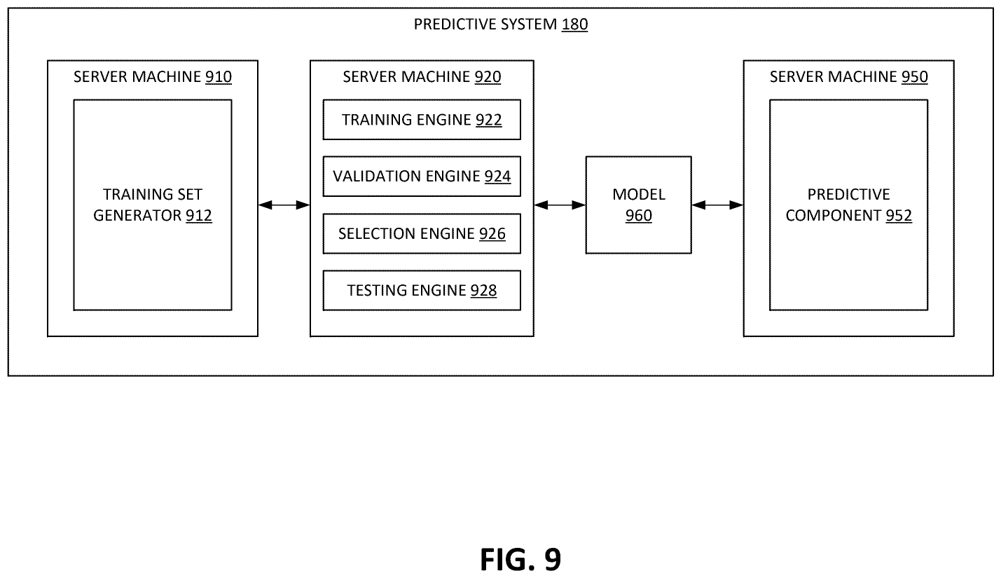

FIG. 9 illustrates an example predictive system, in accordance with implementations of the present disclosure. As illustrated in FIG. 9, predictive system 180 can include a training set generator 912 (e.g., residing at server machine 910), a training engine 912, a validation engine 924, a selection 926, and/or a testing engine 928 (e.g., each residing at server machine 920), and/or a predictive component 952 (e.g., residing at server machine 950). Training set generator 912 may be capable of generating training data (e.g., a set of training inputs and a set of target outputs) to train one or more AI models 960 (e.g., AI model 182, etc.).

In some embodiments, one or more of AI model(s) 960 (e.g., AI model 182) can include a general purpose model that is trained to perform a wide variety of tasks. In such embodiments, training set generator 912 can generate a training data set for training AI model 182 based on a corpus of textual data, audio data, video data, and so forth. The corpus can include a wide array of information gathered from numerous sources, including publicly available web pages (e.g., blogs, forums, news sites, academic papers, online encyclopedias, etc.), books and literature, social media, research papers, public datasets, and so forth. Training set generator 912 can extract features from data of the corpus and can transform the extracted features into a format that the AI model 182 can interpret. In some embodiments, training set generator 912 can perform one or more tokenization operations (e.g., to break down the textual data, audio data, video data, etc. into smaller units called tokens), one or more normalization operations (e.g., to convert the tokens into a common format and/or a format that can be handled by the AI model 182), one or more noise removal operations (e.g., to remove or filter out unwanted data or metadata), and/or one or more data formatting operations (e.g., to structure the tokens uniformly and indicate contextual windows between tokens indicating dependencies between tokens). In some embodiments, training set generator 912 can obtain annotation data for the tokens obtained based on the data of the corpus. Annotation data can include an indication of a classification associated with the token. In some embodiments, the annotation data can be provided by human annotators or according to other annotation techniques. Training set generator 912 can update the training data set to include the extracted features, the generated tokens, and/or the annotation data. As described below, training engine 922 can use the training data to perform the wide range of tasks.

In other or similar embodiments, one or more of AI model(s) 960 can include specific purpose models that are trained to perform specific tasks or operations, in accordance with embodiments described herein. For example, AI model(s) 960 can include a discussion topic model that is trained to predict a set of discussion topics 256 of a discussion of a virtual meeting 160 based on a given meeting transcript 252 for the virtual meeting 160 (or a portion of the virtual meeting 160). In some embodiments, the discussion topic model can include an unsupervised learning model (e.g., a LDA model, a NMF model, etc.). In such embodiments, training set generator 912 may generate training data for training the discussion topic model by identifying content (e.g., textual content, audio content, video content, etc.), which may be collected during virtual meeting(s) 160, obtained from one or more electronic documents of platform 120, or obtained according to other techniques. Training engine 922, as described below, may provide the training data as an input to the discussion topic model, which can identify commonalities between the textual content and/or the audio content. Training engine 922 (or another component of predictive system 180) can group or otherwise cluster content sharing a respective commonality and, in some embodiments, a developer or engineer of platform 120 and/or of system 100 can provide an indication of a topic associated with a respective group or cluster of content (e.g., as ground truth data).

In other or similar embodiments, the discussion topic model can include a supervised learning model (e.g., a BERT model, a fine-tuned transformer model, etc.). In such embodiments, training set generator 912 may generate training data for training the discussion topic model by identifying content, as described above. Training set generator 912 can also identify a topic associated with the content and generate a mapping between the content and the identified content. In some embodiments, a developer or engineer of platform 120 and/or of system 100 can provide an indication of the topic. In other or similar embodiments, training set generator 912 can determine the topic associated with the content based on other data (e.g., metadata) associated with the content. Training set generator 912 can include mapping in the training data set, which is used by training engine 922 for training the discussion topic model, as described herein.

In yet other or similar embodiments, one or more of AI model(s) 960 can include a discussion context model, which may be a specific purpose model that is trained to predict a context and/or a sentiment of given input data. In some embodiments, the discussion context model can be trained according to supervised learning techniques based on a training data set that trains the discussion context model into one of several predefined context or sentiment classes. In some embodiments, the predefined context or sentiment classes can be provided by a developer or operator of system 100 and/or determined based on historical data associated with system 100. Training set generator 912 can obtain historical user queries or statements provided by users of platform 120 and can determine a context or sentiment associated with each respective query or statement (e.g., as provided by the developer or operator of system 100). In other or similar embodiments, the historical user query or statement can be provided by users of other applications of platform 120 and/or other platforms or systems. Training set generator 912 can generate training data for training the discussion context model by generating a mapping between a historical user query or statement, a context of the query or statement, and/or a sentiment of the query or statement.

In yet other or similar embodiments, one or more of AI model(s) 960 can include a topic relevance model, which may be a specific purpose model that is trained to predict a degree of relevance between given content and a respective topic in view of a context or a sentiment of the topic. The topic relevance model can include a BERT model, a fine-tuned classifier model, a prompt-based relevance prediction model, and so forth. The training data generated by training set generator 912 to train the topic relevance model can include a mapping between historical content (e.g., of platform 120 and/or other platforms or systems), a context associated with the historical content, and/or a topic associated with the historical content. The historical content, context, and/or topic can be provided by a developer or engineer of system 100, or can be obtained according to other techniques, in some embodiments.

Training engine 922 can train an AI model 960 using the training data from training set generator 912, as described above. The model 960 can refer to the model artifact that is created by the training engine 922 using the training data that includes training inputs and/or corresponding target outputs (correct answers for respective training inputs). The training engine 922 can find patterns in the training data that map the training input to the target output (the answer to be predicted), and provide the model 960 that captures these patterns. The model 960 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like.

In some embodiments, training engine 922 can first pre-train the AI model 960 on a corpus of text (e.g., generated by or accessible to training set generator 912 and/or training engine 922) to create a foundational model, and afterwards fine-tuned on more data pertaining to a particular set of tasks to create a more task-specific, or targeted, model. The foundational model can first be pre-trained using a corpus of text that can include text context in the public domain, licensed content, and/or proprietary content. Such a pre-training can be used by the model to learn broad language elements including general sentence structure, common phrases, vocabulary, natural language structure, and any other elements commonly associated with natural language in a large corpus of text. In some embodiments, this first, foundational model can be trained using self-supervision, or unsupervised training on such datasets.

In some embodiments, the AI model 960 can then be further trained and/or fine-tuned on organizational data, including proprietary organizational data. The AI model 960 can also be further trained and/or fine-tuned on organizational data associated with a virtual meeting 160 and/or other documents, including proprietary organizational data associated with a virtual meeting 160 and/or other documents.

In some embodiments, the second portion of training, including fine-tuning, may be unsupervised, supervised, reinforced, or any other type of training. In some embodiments, this second portion of training may include some elements of supervision, including learning techniques incorporating human or machine-generated feedback, undergoing training according to a set of guidelines, or training on a previously labeled set of data, etc. In a non-limiting example associated with reinforcement learning, the outputs of the AI model 960 while training may be ranked by a user, according to a variety of factors, including accuracy, helpfulness, veracity, acceptability, or any other metric useful in the fine-tuning portion of training. In this manner, the AI model 960 can learn to favor these and any other factors relevant to users within an organization, or associated with a virtual meeting, when generating a response. In such a way, a foundational model can be further trained to perform within a virtual meeting, and provide useful information, as well as help to accomplish useful tasks associated with the virtual meeting.

In some embodiments, the AI model 960 may include one or more pre-trained models, or fine-tuned models. In a non-limiting example, in some embodiments, the goal of the “fine-tuning” may be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In one embodiment, the AI model 960 may be one or more of decision trees, random forests, support vector machines, or other types of machine learning models. In one embodiment, the AI model 960 may be one or more artificial neural networks (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

In some embodiments, the AI model 960 may be one or more recurrent neural networks (RNNs). An RNN is a type of neural network that includes a memory to enable the neural network to capture temporal dependencies. An RNN is able to learn input-output mappings that depend on both a current input and past inputs. The RNN will address past and future measurements and make predictions based on this continuous measurement information. One type of RNN that may be used is a long short term memory (LSTM) neural network.

As indicated above, the AI model 960 may be one or more generative AI models, allowing for the generation of new and original content. The generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks.

Validation engine 924 may be capable of validating a trained model 960 using a corresponding set of features of a validation set from training set generator 912. The validation engine 924 may determine an accuracy of each of the trained models 960 based on the corresponding sets of features of the validation set. The validation engine 924 may discard a trained model 960 that has an accuracy that does not meet a threshold accuracy. In some embodiments, the selection engine 926 may be capable of selecting a trained model 960 that has an accuracy that meets a threshold accuracy. In some embodiments, the selection engine 926 may be capable of selecting the trained model 960 that has the highest accuracy of the trained models 960.

The testing engine 986 may be capable of testing a trained model 960 using a corresponding set of features of a testing set from training set generator 912. For example, a first trained model 960 that was trained using a first set of features of the training set may be tested using the first set of features of the testing set. The testing engine 928 may determine a trained model 960 that has the highest accuracy of all of the trained machine learning models based on the testing sets.

As described herein, predictive component 952 of server 950 may be configured to feed data as input to model 960 and obtain one or more outputs. In some embodiments, predictive component 952 can include or be associated with meeting resource engine 156.

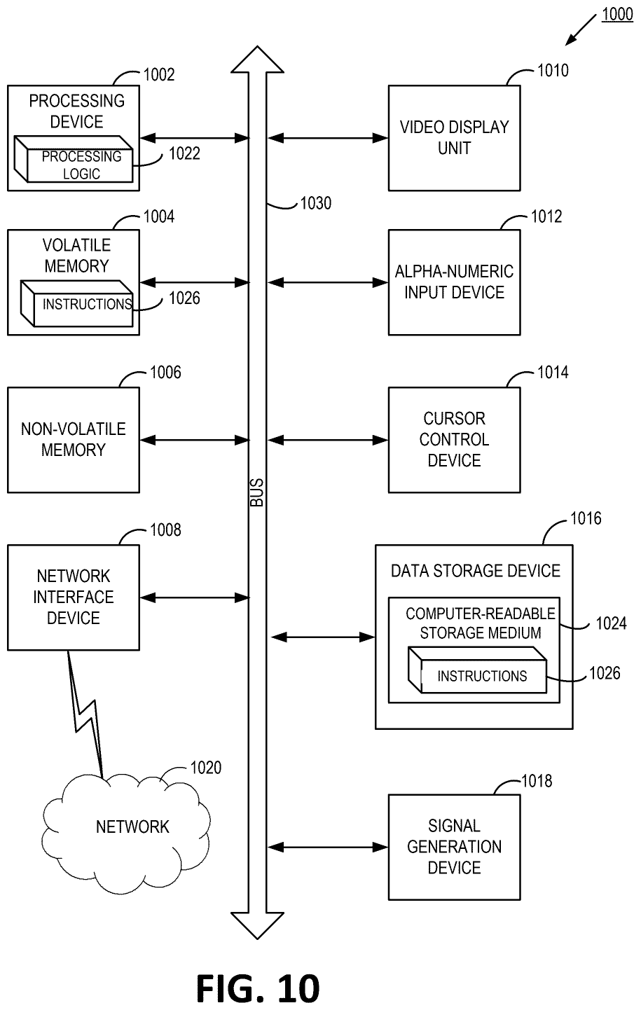

FIG. 10 is a block diagram illustrating an exemplary computer system 1000, in accordance with implementations of the present disclosure. The computer system 1000 can correspond to platform 120 and/or client devices 102A-N, described with respect to FIG. 1. Computer system 1000 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processing device (processor) 1002, a main memory 1004 (e.g., read-only memory (ROM), flash memory, dynamic random access memory (DRAM) such as synchronous DRAM (SDRAM), double data rate (DDR SDRAM), or DRAM (RDRAM), etc.), a static memory 1006 (e.g., flash memory, static random access memory (SRAM), etc.), and a data storage device 1018, which communicate with each other via a bus 1040.

Processor (processing device) 1002 represents one or more general-purpose processing devices such as a microprocessor, central processing unit, or the like. More particularly, the processor 1002 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 can also be one or more special-purpose processing devices such as an application specific integrated circuit (ASIC), a field programmable gate array (FPGA), a digital signal processor (DSP), network processor, or the like. The processor 1002 is configured to execute instructions 1005 for performing the operations discussed herein.

The computer system 1000 can further include a network interface device 1008. The computer system 1000 also can include a video display unit 1010 (e.g., a liquid crystal display (LCD) or a cathode ray tube (CRT)), an input device 1012 (e.g., a keyboard, and alphanumeric keyboard, a motion sensing input device, touch screen), a cursor control device 1014 (e.g., a mouse), and a signal generation device 1020 (e.g., a speaker).

The data storage device 1018 can include a non-transitory machine-readable storage medium 1024 (also computer-readable storage medium) on which is stored one or more sets of instructions 1005 embodying any one or more of the methodologies or functions described herein. The instructions can also reside, completely or at least partially, within the main memory 1004 and/or within the processor 1002 during execution thereof by the computer system 1000, the main memory 1004 and the processor 1002 also constituting machine-readable storage media. The instructions can further be transmitted or received over a network 1030 via the network interface device 1008.

In one implementation, the instructions 1005 include instructions for providing fine-grained version histories of electronic documents at a platform. While the computer-readable storage medium 1024 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
obtaining a transcript for at least a portion of a virtual meeting;
determining a plurality of discussion topics of a discussion of the virtual meeting based on the obtained transcript;
obtaining, based on the obtained transcript and the plurality of topics, a plurality of topic summaries each summarizing a respective topic of the plurality of topics that is discussed at various points in time during the virtual meeting; and
generating an overview of the virtual meeting, wherein the overview comprises the plurality of topic summaries in association with respective topics discussed at various points of time during the virtual meeting.

2. The method of claim 1, wherein determining the plurality of discussion topics of the discussion comprises:
providing the transcript as input to a first artificial intelligence (AI) model that is trained to predict one or more discussion topics of a discussion based on given transcript data; and
obtaining one or more outputs of the first AI model.

3. The method of claim 1, wherein obtaining the plurality of topic summaries comprises:
providing the transcript as input to a second AI model that is trained to generate a summary of a discussion of a virtual meeting based on given transcript data; and
obtaining one or more outputs of the second AI model.

4. The method of claim 1, wherein the transcript is a live transcript obtained while the virtual meeting is being conducted, the live transcript comprising current content discussed by a plurality of participants of the virtual meeting.

5. The method of claim 4, further comprising:
updating a user interface (UI) of the virtual meeting to include the generated overview for presentation to the plurality of participants during the virtual meeting.

6. The method of claim 4, further comprising;
obtaining, during a subsequent time period of the virtual meeting, the live transcript for at least another portion of the virtual meeting;
obtaining an updated topic summary that summarizes the respective topic discussed at the subsequent time period; and
updating the overview of the virtual meeting to comprise the updated topic summary in association with the respective topic.

7. The method of claim 1, wherein the transcript is a post-meeting transcript generated based on a complete discussion of participants during the virtual meeting.

8. The method of claim 1, wherein a respective topic summary that summarizes the respective topic of the discussion comprises one or more of:
an indication of an evolution of a status of the respective topic between an initial time period of the discussion and a subsequent time period of the discussion, or
an indication of a final status pertaining to the respective topic at a final time period of the discussion.

9. A system comprising:
a memory; and
a set of one or more processing devices, coupled to the memory, configured to perform operations comprising:
obtaining a transcript for at least a portion of a virtual meeting;
determining a plurality of discussion topics of a discussion of the virtual meeting based on the obtained transcript;
obtaining, based on the obtained transcript and the plurality of topics, a plurality of topic summaries each summarizing a respective topic of the plurality of topics that is discussed at various points in time during the virtual meeting; and
generating an overview of the virtual meeting, wherein the overview comprises the plurality of topic summaries in association with respective topics discussed at various points of time during the virtual meeting.

10. The system of claim 9, wherein determining the plurality of discussion topics of the discussion comprises:
providing the transcript as input to a first artificial intelligence (AI) model that is trained to predict one or more discussion topics of a discussion based on given transcript data; and
obtaining one or more outputs of the first AI model.

11. The system of claim 9, wherein obtaining the plurality of topic summaries comprises:
providing the transcript as input to a second AI model that is trained to generate a summary of a discussion of a virtual meeting based on given transcript data; and
obtaining one or more outputs of the second AI model.

12. The system of claim 9, wherein the transcript is a live transcript obtained while the virtual meeting is being conducted, the live transcript comprising current content discussed by a plurality of participants of the virtual meeting.

13. The system of claim 12, wherein the operations further comprise:
updating a user interface (UI) of the virtual meeting to include the generated overview for presentation to the plurality of participants during the virtual meeting.

14. The system of claim 12, wherein the operations further comprise:
obtaining, during a subsequent time period of the virtual meeting, the live transcript for at least another portion of the virtual meeting;
obtaining an updated topic summary that summarizes the respective topic discussed at the subsequent time period; and
updating the overview of the virtual meeting to comprise the updated topic summary in association with the respective topic.

15. The system of claim 9, wherein the transcript is a post-meeting transcript generated based on a complete discussion of participants during the virtual meeting.

16. A non-transitory computer readable storage medium comprising instructions that, when executed by a set of one or more processing devices, cause the set of one or more processing devices to perform operations comprising:
obtaining a transcript for at least a portion of a virtual meeting;
determining a plurality of discussion topics of a discussion of the virtual meeting based on the obtained transcript;
obtaining, based on the obtained transcript and the plurality of topics, a plurality of topic summaries each summarizing a respective topic of the plurality of topics that is discussed at various points in time during the virtual meeting; and
generating an overview of the virtual meeting, wherein the overview comprises the plurality of topic summaries in association with respective topics discussed at various points of time during the virtual meeting.

17. The non-transitory computer readable storage medium of claim 16, wherein determining the plurality of discussion topics of the discussion comprises:
providing the transcript as input to a first artificial intelligence (AI) model that is trained to predict one or more discussion topics of a discussion based on given transcript data; and
obtaining one or more outputs of the first AI model.

18. The non-transitory computer readable storage medium of claim 16, wherein obtaining the plurality of topic summaries comprises:
providing the transcript as input to a second AI model that is trained to generate a summary of a discussion of a virtual meeting based on given transcript data; and
obtaining one or more outputs of the second AI model.

19. The non-transitory computer readable storage medium of claim 16, wherein the transcript is a live transcript obtained while the virtual meeting is being conducted, the live transcript comprising current content discussed by a plurality of participants of the virtual meeting.

20. The non-transitory computer readable storage medium of claim 19, wherein the operations further comprise:
updating a user interface (UI) of the virtual meeting to include the generated overview for presentation to the plurality of participants during the virtual meeting.
